(19) United States
(12) Patent Application Publication
(10) Pub. No.: US 2008/0226784 A1
(43) Pub. Date: Sep. 18, 2008

(54) Corn mill having increased through production

(75) Inventor: Peter Matthews, Katy, TX (US)

Correspondence Address: CRAIN, CATON & JAMES, FIVE HOUSTON CENTER, 1401 MCKINNEY, 17TH FLOOR, HOUSTON, TX, 77010, US

(73) Assignee: SATAKE USA, INC., Stafford, TX (US)

(21) Appl. No.: 12/013,532

(22) Filed: Jan. 14, 2008

Related U.S. Application Data
(60) Provisional application No. 60/894,974, filed on Mar. 15, 2007.
(60) Provisional application No. 60/973,641, filed on Sep. 19, 2007.

(51) Int. Cl. A23L 1/10; B02C 23/16

(52) U.S. Cl. 426/443; 241/73

(57) ABSTRACT

An internal milling device for milling of corn or other grains and in particular for debranning corn kernels, or kernels or the like, and exposing or freeing germ in dry milling. The improvements include a modified internal milling rotor, modified screen sieve, additional and modified breaker bars, and an improved particle removal system.

### CROSS REFERENCE TO RELATED APPLICATIONS

This application claims the benefit of U.S. Provisional Patent Application No. 60/894,974 entitled “Corn Mill” filed on Mar. 15, 2007 in the United States Patent and Trademark Office and of U.S. Provisional Patent Application No. 60/973,641 entitled “Corn mill having increased through production” filed on Sep. 19, 2007 in the United States Patent and Trademark Office.

### STATEMENT REGARDING FEDERALLY SPONSORED RESEARCH OR DEVELOPMENT

Not Applicable.

### BACKGROUND OF THE INVENTION

1. Field of the Invention

The present invention relates to an improvement to machines for milling of maize, commonly referred to as corn, and in particular for debranning corn kernels and exposing or freeing germ. Other grains may be milled as well. The embodiment may be used in dry milling and in wet milling. Particularly, the improvement is directed to vertical mills, although it may also be used in horizontal mills. Most particularly, this improvement pertains to milling machines identified as degermers. The improvements include a modified internal milling rotor, modified screen sieve, additional and modified breaker bars, and an improved particle removal system. An improved degerming machine may include less than all improvements.

2. Description of the Related Art

Corn milling machines are well known wherein corn kernels are debranned and the germ freed or exposed by application of impact force. In dry milling, the steeping step is omitted, although the corn is tempered in water to permit the moisture content of the corn to increase, before being introduced to the mill. In wet milling, the corn kernel is steeped in an aqueous solution so the various parts—bran, endosperm and germ—may absorb sufficient water to be milled. The corn kernels are then removed from the water and supplied from a feeding inlet to a milling chamber having a milling rotor, which serves as an impeller. The kernels are then circulated by the milling rotor and milled until exiting. The milling rotor may include one or more resistance bars mounted on the rotor within the milling chamber. During circulation, kernels may be intermittently compressed, thereby fracturing the kernel and, when compressed and abrasively contacting one another, causing bran to separate from the bran and/or germ. A perforated screen may surround the milling chamber to permit kernel fragments, generally referred to as brokens, which may be germ, endosperm, bran or a combination thereof, of less than a maximum size to exit the milling chamber. The force applied to the kernels may also be affected by selection of the screen, which may retard kernels moving through the milling chamber, induce kernels to move more rapidly through the milling chamber, or have no effect on the speed at which the kernels pass through the milling chamber. Sufficient milling for exposing germ or for reduction of the kernel broken size may be controlled by requiring a minimum force be applied to a discharge gate by or through the adjacent kernels. Removal of sufficiently milled kernel brokens prior to reaching the top of the milling chamber may be permitted by sufficiently sized perforations in the screen.

Various milling systems are known in the art for degerming of kernels. Some degermer are horizontally aligned, wherein kernels are input at one end of a horizontal-oriented mill, travel horizontally during milling and then exit. The Beall-type degermer is one such well-known horizontally-oriented mill. In a Beall-type degermer, corn is fed into and through the annulus at one end and between a rotating, conical rotor and a stationary concentric screen made of perforated metal. Both rotor and screen are textured with large nodes, which impede motion of the kernels as they are impelled by the rotor. A weighted discharge gate may be used to control the pressure and corn density in the process. This process dislodges germ from the endosperm by impact and bending stresses as the kernels move through the annulus and results in breakage of most of the kernels. As bran layers may remain with the pieces of endosperm after processing, further refinement may be necessary to reduce the fiber content of the endosperm product.

Alternatively, vertical degermers may be used. Vertical degermers are known in the art wherein corn, or other grains, is continuously introduced to the mill at its base, which drives the previously-entered kernels upward. One such machine is the Satake Maize Degermer VBF. During rotation of the milling rotor in a vertical degermer, the corn is circulated horizontally by the milling rotor and is retained by the surrounding screen while being lifted by injection of additional corn from the base and induced upward by angled, elongated orifices through the screen. It is well known in the art that a polygonal screen rather than one that is circular may be used to vary the compression on the kernel during processing. Use of a polygonal screen results in compression of the kernel most particularly at the point where the screen and milling rotor are closest. Additionally, breaks or breaker bars may be installed about the screen that produce further localized areas of compression, which result in further fracturing of the kernels, or propagation of existing fractures within the kernels.

Problematically, kernels that are sufficiently fractured early in the milling process continue to be milled with insufficiently fractured kernels, often resulting in excessive milling and thereby degradation of products. It is generally desirable to minimize the production of fine particles, as the fine particles are difficult to separate in order to recover them as a corn product. As a result breaker bars have been used in the prior art solely at the upper section of the screen in such vertical degermers to accelerate fracturing of the kernels immediately prior to discharge. The thickness of breaker bars substantially affects the output and milling time, as well as the power applied by the milling rotor to the kernels. Brokens generated by the milling are permitted to leave the milling chamber by holes or slots in the screens and collect at the base of the screen. Those brokens passing through the screen are known as throughs. The throughs are then ejected into piping by a paddle affixed to the lower section of the milling roller. The piping is connected to a negative or reduced pressure system, such as a vacuum pump, to draw the throughs along the piping, often laterally, and to a throughs collector. This is typically performed under general exhaust.

Additionally, the screen surrounding the milling chamber wears, and often wears unevenly, particularly at the bottom. The constant abrasion of the corn kernels wears the periphery of the perforations of the screen. Due to the forces generated at the point of introduction of the corn kernels, particularly the bottom of the milling chamber in the vertical degermer, the screens wear first adjacent the point of introduction of the corn kernels. Such wear requires frequent screen replacement even though the upper portions of the screen remain usable.

It is known in the art to temper the corn kernels to be milled by addition of a measured amount of water. Tempering permits control of the softening and expansion of bran layers while avoiding or limiting penetration of water into germ or endosperm. Absorption of water renders the layers of bran more pliable, and weakens the bond of bran to germ and endosperm. The water may be in liquid or steam form, or may be combined with other chemicals. The corn kernels are then retained in a holding tank for a specific period of time to obtain the desired level of moisture absorption. Various tempering methods are known to produce the desired moisture absorption.

With the rise of bio-energy as an alternative to petroleum fuels, particularly in the nature of ethanol, the demand for endosperm, from which starch may be obtained, has increased.

The prior art processes resulted in unacceptable percentages of fine particles of endosperm that are difficult to separate from the bran and germ particles in order to recover them as a corn product.

There is therefore a need for a mill which more efficiently mills the corn kernels.

It would therefore be an improvement to affect the corn kernels with breaker bars earlier in the milling process and to provide a system for removal of sufficiently fractured corn kernels throughout the milling process.

It would therefore be a further improvement to induce more friction among the kernels in the milling chamber by surface conditions on the milling rotor.

It would also be an improvement to separate endosperm from the kernel and to maintain the endosperm in the largest possible particle size,

It would also be an improvement to provide a system capable of placing the milling chamber under a lowered air pressure to remove the larger quantity of throughs produced from the improved milling device.

### SUMMARY OF THE INVENTION

Accordingly, it is an object of the present invention to provide a process and apparatus for increasing the production of large particles of endosperm, and thus maximize yields of low-fat corn products and improve the value of the products.

The present invention increases the effectiveness of a conventional vertical mill, typically of the type of vertical mill having a central rotor shaft with one or more resistance bars, i.e. protuberances, thereon, by introduction of several improvements. These improvements include one or more breaker bars affixed to the outer edge of the milling chamber below the standard row of breaker bars. The improvements further include multiple uniformly-spaced protuberances on the milling rotor coplanar with the standard and additional breaker bars. Additionally, uniformly spaced perforations in the screen are sized to permit throughs to escape the milling chamber and are not oriented to speed or retard processing through the milling chamber are provided. The improvements further include a segmented screen that includes a removable lower section to permit replacement after wear. The improvements further include a gravity separation of small and large throughs. The present invention increases the surfaces to fracture kernels, propagates earlier fractures through the kernels to permit degerming, sufficiently mills particles before reaching the discharge gate opening, and facilitates separation of tails and throughs.

The present invention also provides a mill having increased effectiveness in debranning kernels and exposing or freeing the germ without excessive production of fines and flour. Unlike conventional mills, the present invention includes breaker bars at two vertical positions at the periphery of the milling chamber. The breaker bars intermittently increase the compressive force in the kernel about the breaker body not merely at the vertical position of the discharge gate opening, but also at planes below the discharge gate opening. The edge of each breaker bar provides the location for fracturing the bran and endosperm. The blade body terminates to provide an area for kernel decompression that may also encourage propagation of cracks within the kernels. A screen may be used to induce fracturing of kernels and to permit sufficiently milled kernel particles. Importantly in the present invention, the screen may be perforated with round orifices, which neither retard to induce vertical movement in the milling chamber, rather than slots, which are intended to increase or retard kernel flow through the milling chamber. Production of sufficiently milled particles, without excessive production of fines or flour, results.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 illustrates a cross-sectional top view of a whole corn kernel.

FIG. 2 illustrates a front view of a debranned corn kernel.

FIG. 3 illustrates a side view of a debranned corn kernel.

FIG. 4 illustrates a cross-sectional side view of a typical milling machine known in the art.

FIG. 5 illustrates a cross sectional side view of the feed inlet for the milling machine illustrated in FIG. 4.

FIG. 6 illustrates an exploded view of a milling rotor known in the art.

FIG. 7 illustrates an isometric view of the front and rear frames which retain the screen sections to define the outer edge the milling chamber.

FIG. 8 illustrates a view of the front and rear sections of the screen with the row of breaker bars known in the prior art.

FIG. 9 illustrates a top view of a breaker bar installed at the top of a screen.

FIG. 10 illustrates a front view of the front and rear screens of the present invention.

FIG. 11 illustrates an exploded view of a milling rotor of the present invention.

FIG. 12 illustrates a side view of the present invention illustrating the throughs product discharge collector.

### DETAILED DESCRIPTION OF THE PREFERRED EMBODIMENT

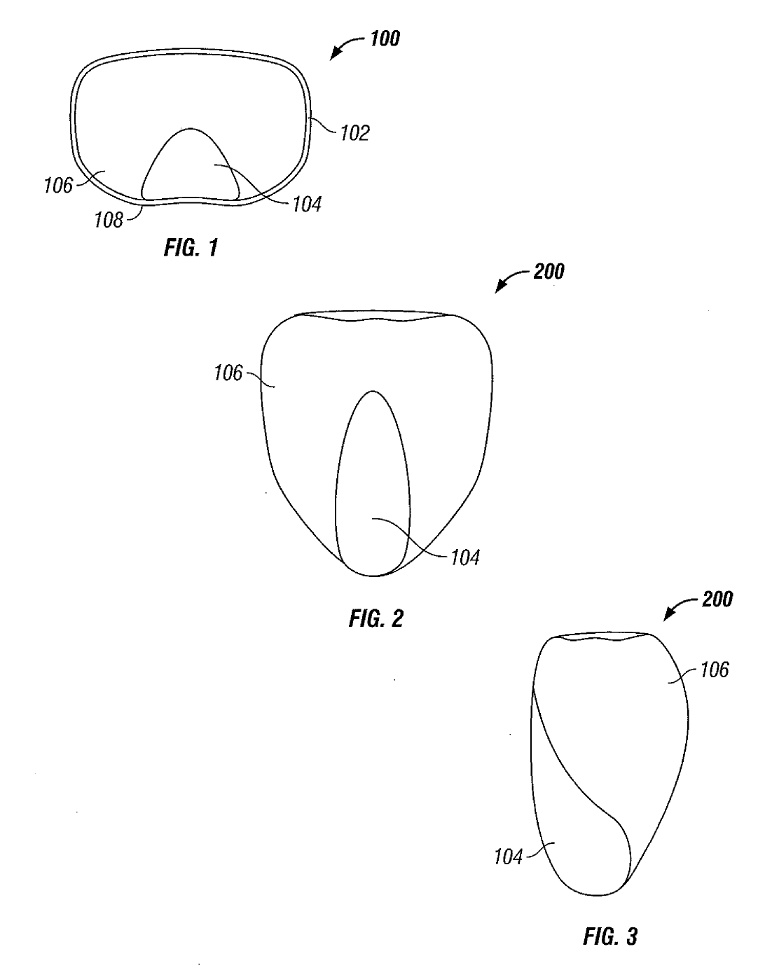

Referring first to FIG. 1, a corn kernel 100 is illustrated for reference as to terms used herein. As illustrated in FIG. 1, a typical corn kernel 100 includes bran 102, germ 104, and endosperm 106. As illustrated in FIG. 1, the germ 104 is embedded in one of the large, relatively flat sides 108 of kernel 100. A debranned kernel 200, comprising generally germ 104 and endosperm 106, is illustrated in FIGS. 2 and 3 from a front and side view, respectively, As used herein, “debranned” refers to a kernel having some, though not necessarily all, bran removed.

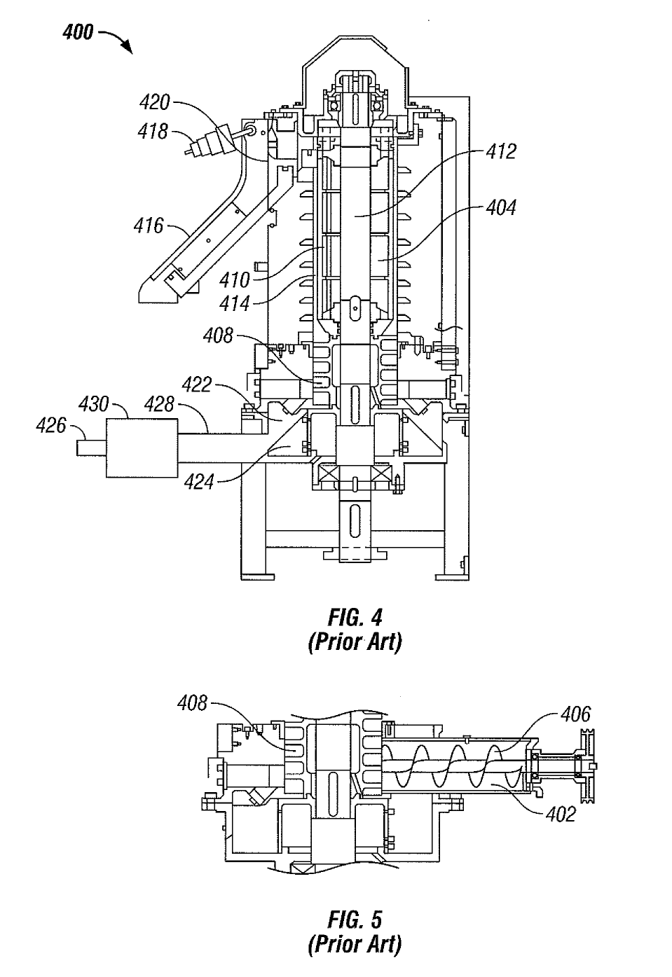

A vertical mill 400 of a type known in the art is disclosed in FIG. 4. The purpose of mill 400 is to generally cause a portion of the bran 102 encasing the kernel 100 to be removed and to fracture the endosperm 106 sufficient to provide access to and/or to free the germ 104 attached thereto. The mill 400 also permits on-going removal of sufficiently milled brokens that may be separated into bran 102, germ 104, and endosperm 106 thereafter. As a result of the vertical orientation, vertical mill 400 has a top and a bottom. As illustrated in FIGS. 4 and 5, a detail of the bottom inlet portion of vertical mill 400, in operation, kernel 100 is introduced to the mill 400 via a feeding inlet 402 located proximate the bottom of the milling chamber 404, from which point the kernel 100 is conveyed by a feed screw 406 to a feed rotor 408, which conveys the kernels 100 to milling chamber 404. Alternative methods for introducing kernels 100 to milling chamber 404 at feeding inlet 402 are known in the art.

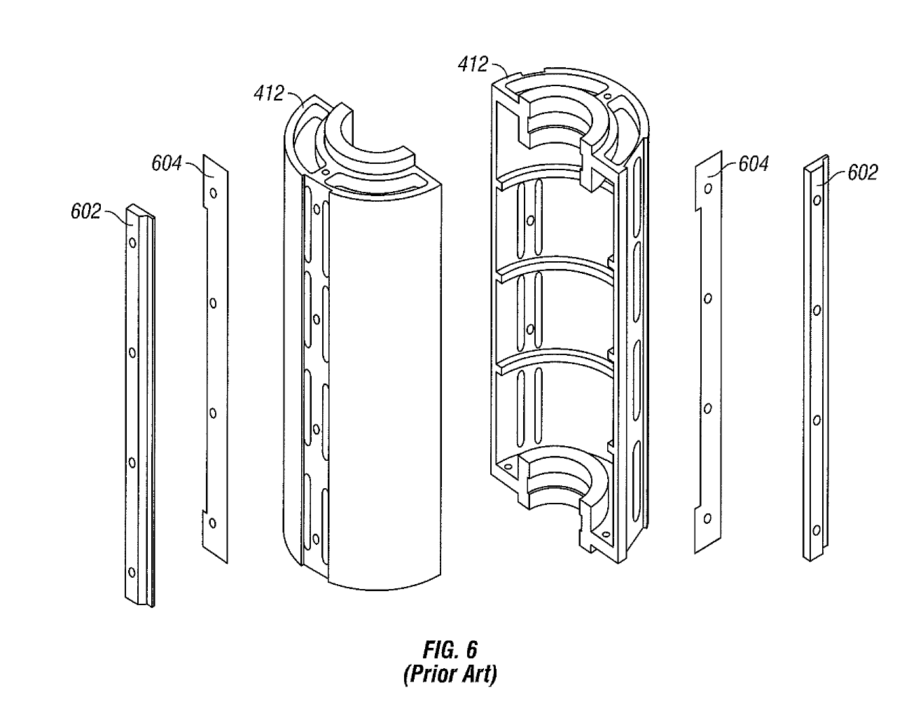

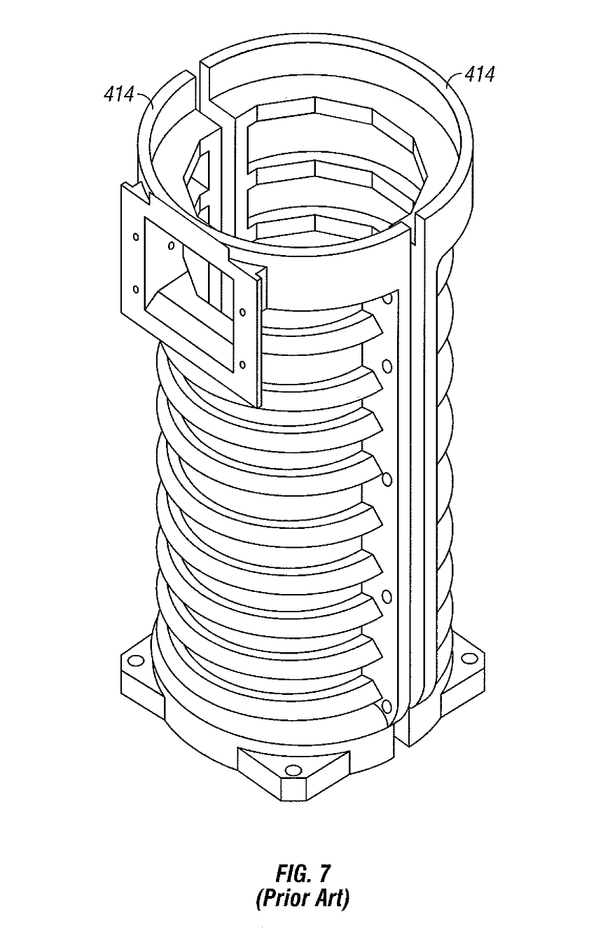

A vertically-disposed milling rotor 412, located in milling chamber 404, is of a type known in the art. Referring to FIG. 6, the vertically-disposed milling roller 412 includes on its surface at least one resistor bar 602 and may include a spacer 604 between the resistor bar 602 and the milling rotor 412. Any number of resister bars may be affixed to the milling rotor 412. As illustrated in FIG. 6, the milling rotor includes include two resistor bars 602 each with one spacer 604, although a mounting location for a third resistor bar 602 is found on the face of milling rotor 412.

Returning to FIG. 4, it is known that during rotation of milling rotor 412, kernels 100 are induced to move in multiple planes by surface friction from adjacent kernels 100, by the surface of milling rotor 412 and by the surface of resistor bars 602 illustrated in FIG. 6. It is also known to place a screen 410 surrounding milling rotor 412 and milling chamber 404 to provide the outer boundary of milling chamber 404. Screen 410 is retained in place by frames 414, illustrated in greater detail in FIG. 7.

As kernels 100 are forced into milling chamber 404 by feed rotor 408, the kernels 100 previously introduced are pushed toward the top of milling chamber 404 where milling chamber 404 communicates with a discharge gate at discharge outlet 420. The amount of force exerted on materials to be milled, which may include kernels 100, debranned kernels 200, and brokens thereof, within milling chamber 404 may be controlled in part by the force necessary to open discharge gate at discharge outlet 420, which may be varied by a weight 418 or any spring combination, and by the feed rate and force of feed rotor 408. Absent the necessary force, the discharge gate does not open, retaining the materials to be milled within the mill 400 and resulting in additional milling within milling chamber 404.

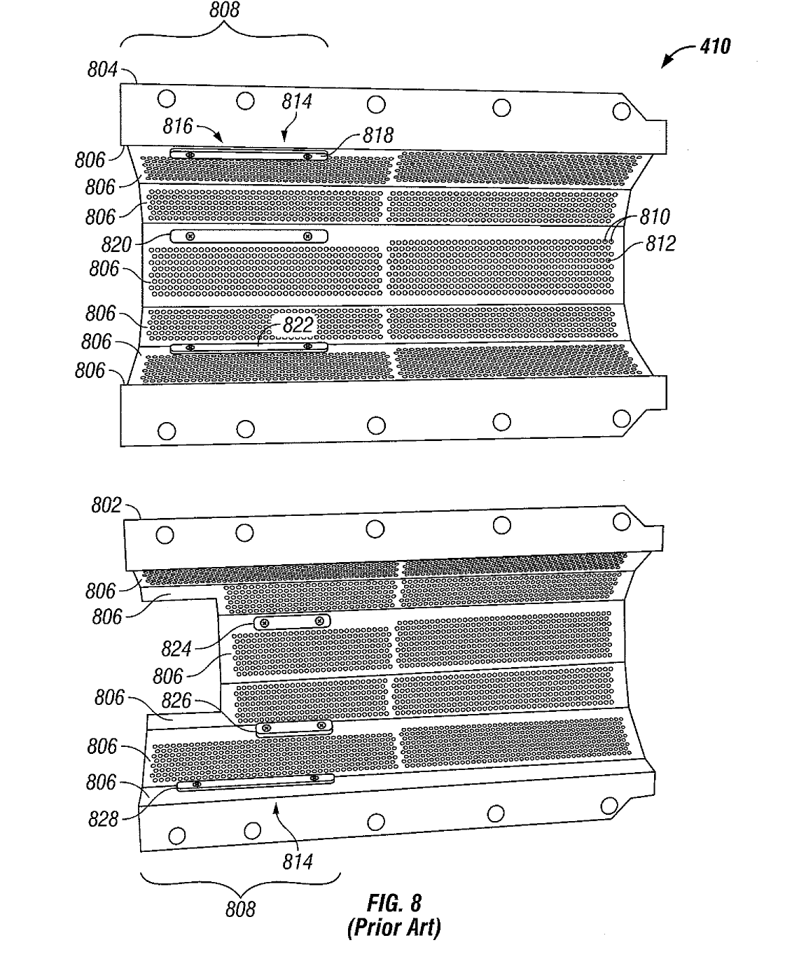

As illustrated in FIG. 8, a typical screen 410 is constructed in two sections, a front screen 802 and a rear screen 804. Screen 410 is constructed to fit within frame 414 (illustrated in FIGS. 4 and 7), and may be constructed to present a constant surface or any number of panels, preferably as an equilateral polygon. As illustrated, screen 410, when assembled, has twelve panels 806. At least one panel 806 includes perforations 810 which permit brokens smaller than the perforation 810 to escape the milling chamber 404 and which may be arranged in rows 812. Variations in the selection of the perforations 810 are well-known the art, including perforation size, shape and orientation. As illustrated in FIG. 8, round perforations 810 are included on ten of the twelve panels 806. Perforations are not included on those panels 806 which are adjacent the portion of two-part frame 414 (illustrated in FIGS. 4 and 7) where the two sections mount together and therefore do not permit communication through the screen 410. These perforations provide surface edges against which materials to be milled may rub during rotation within the milling chamber 404 (illustrated in FIG. 4). As can be appreciated, as the surfaces of materials to be milled contact other materials to be milled, and the perforations 810, the bran 102 may be dislodged from the materials to be milled, transforming them to debranned kernels 200 and brokens thereof.

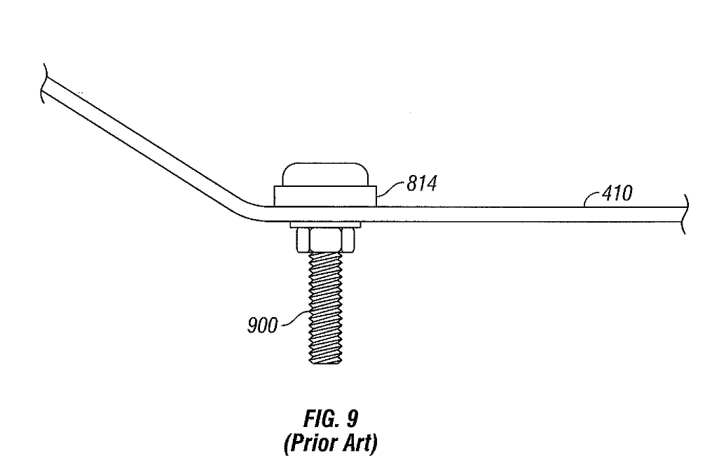

Front screen 802 fits about discharge outlet 420 (illustrated in FIG. 4) and therefore has reduced surface area on the panels 806 communicating with discharge outlet 420. Screen 410 has an upper section 808, typically the upper one-third of screen 410. It is known in the prior art to increase the milling process by affixing breaker bars 814 to the screen 410, which is affixed to frame 414. It is also known to place the breaker bars 814 in a row 816 in the upper section 808 of the screen 410, as lower placement may result in overmilling of kernels 100 before exiting milling chamber 404 through discharge gate 420. As illustrated in FIG. 8, breaker bars 814 may be vertically-oriented and comprise breaker bars 818, 820, 822 and 828 which nearly span the upper section 808 and breaker bars 824 and 826 sized to fit the portion of length of upper section 808 reduced by discharge outlet 420. Each breaker bar 814 is positioned proximate the intersection of two panels 806 to produce localized areas of compression, particularly when a resistor bar 602 (illustrated in FIG. 6) rotates past. The breaker bars 814 may be affixed to screen 410 in any manner, but are most commonly affixed with a bolt and nut assembly 900 as illustrated in FIG. 9.

It is most desirable that the kernels 100 be milled only once. As used herein, milling refers to each introduction of the kernel 100 into a milling chamber 404. Likewise, it is most desirable the corn kernels 100 be sufficiently fragmented, particularly that the kernel be separated among bran, germ and endosperm, and thereafter removed from the milling chamber 404 before being milled into overly small “fines.” In the art, parts of kernels 100 which are not sufficiently milled to exit the milling chamber 404 through screen 410 prior to reaching the discharge spout 416 are referred to as “overtails” or as “tails,” while parts of kernels 100, in the form of fragments of bran 102, germ 104, and endosperm 106, or combinations thereof, which are sufficiently milled to exit the milling chamber 404 prior to passing through discharge spout 416 are referred to as the “through stream” or “through stock.”

In the prior art, only twenty percent (20%) of the bran 102, germ 104 and endosperm 106, by mass, entering milling chamber 404 exited as throughs, while eighty percent (80%) of the bran 102, germ 104 and endosperm 106, by mass, exited as tails. As the tails contained large amounts of endosperm, the prior art required extensive further milling.

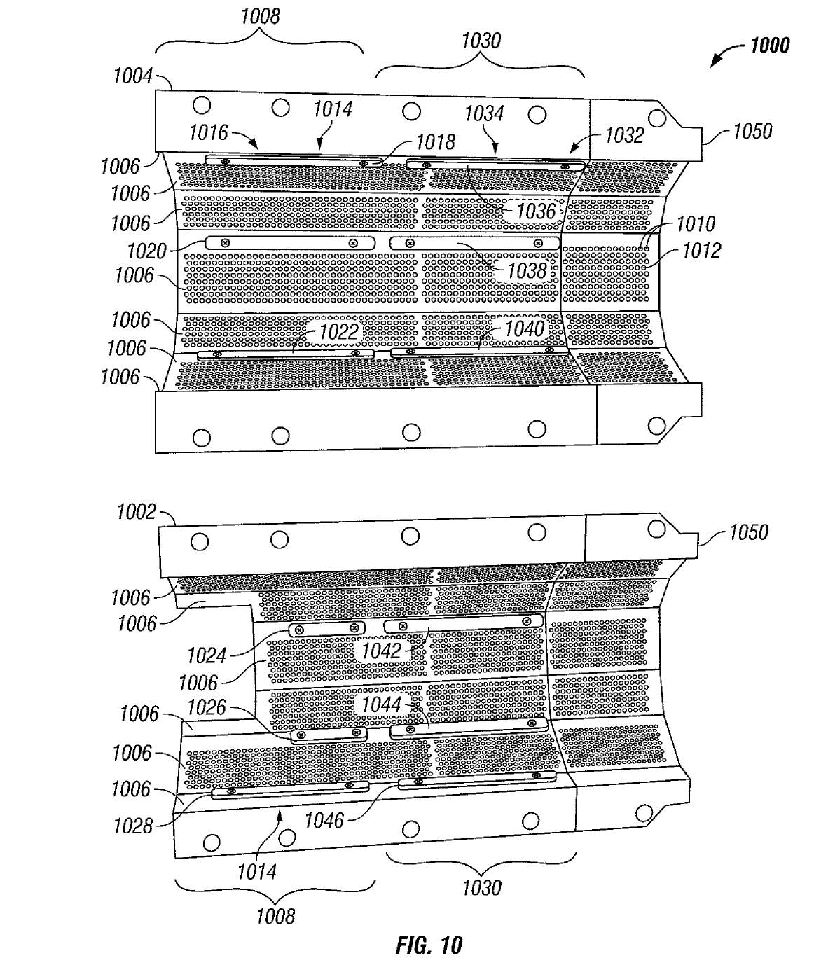

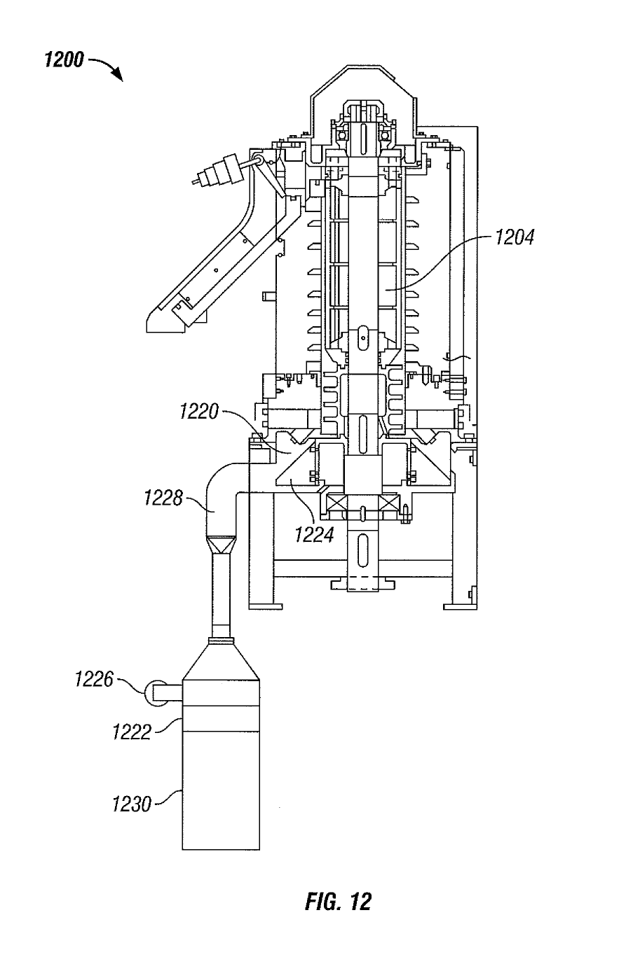

As illustrated in FIG. 10, the improvements to the corn mill provide a higher percentage of throughs and a lower percentage of tails. In one embodiment screen 1000 is approximately 646 mm in height, approximately 281 mm in diameter at its outer diameter, and contains rows 1012 of round perforations 1010 each having a diameter of approximately 9 mm and arranged in rows from proximate the top of screen 1000 to proximate it bottom on each panel 1006 not adjacent the portion of two-part frame 414 where the two sections mount together. For 9 mm round perforations, the perforations are arranged in rows on 17 mm centers, where the rows are arranged in 8.5 mm centers and advanced laterally by 8.5 mm, although smaller centers may be used for more aggressive milling and through removal. Conversely, larger centers may be used for less aggressive milling and through removal. The milling rotor (not shown) has a diameter of approximately 250 mm. Alternatively, perforations 1010 may be of sizes other than 9 mm, such as a 7 mm diameter. Perforations 1010 ideally should be at least 6 mm in diameter and not more than 10 mm in diameter. Similarly, as can be appreciated, other dimensions may be used without departing from the spirit of the invention. More aggressive milling may be obtained by increasing the height of the screen 1010, and therefore roller height, by reducing the diameter of the screen 1000, by decreasing the relative size of the lower or third section 1050 of the screen 1000, or by using a negative perforation, i.e. a slotted perforation which retards rather than encourages passage of corn through the mill 1200 illustrated in FIG. 12.

Like the prior art, screen 1000 includes a row 1016 of breaker bars 1014 affixed in the upper section 1008 of the screen 1000. The breaker bars 1014 may be vertically-oriented. The first row 1016 of breaker bars 1014 comprise breaker bars 1018, 1020, 1022 and 1028 which nearly span the upper section 808 and breaker bars 824 and 826 sized to fit the portion of length of upper section 808 reduced by discharge outlet 420. As in the prior art, each breaker bar 1014 is positioned proximate the intersection of two panels 1006 to produce localized areas of compression, particularly when a resistor bar 602 rotates past. In connection with screen 1000 described above, breaker bars 1018, 1020, 1022, and 1028 are approximately 4 mm thick, approximately 200 mm long and approximately 15 mm wide. In connection with the described milling rotor and chamber, breaker bars 1024 and 1026 are approximately 4 mm thick, approximately 100 mm long and approximately 15 mm wide. Likewise, the total number of breaker bars 1014 and their respective sizes may be altered to provide at least one breaker bar 1014 at the upper section of screen 1000 including adjacent discharge outlet 420.

In the preferred embodiment, screen 1000 includes a separable lower section 1050. Lower section 1050 may be removed and replaced when worn, eliminating the need to replace the less worn remainder of screen 1000.

In the preferred embodiment, screen 1000 further includes a second row 1034 of breaker bars 1032 affixed to the center section 1030 of screen 1000. The second row 1034 of breaker bars 1032 may be vertically-oriented and comprise breaker bars 1036, 1038, 1040, 1042, 1044, and 1046 which nearly span the center section 1030 and which are of uniform size. In connection with the described milling rotor and chamber, each breaker bar 1032 is approximately 4 mm thick, approximately 15 mm wide, and approximately 200 mm long.

The first row 1016 of breaker bars 1014 and, unlike the prior art, second row 1034 of breaker bars 1032 produce localized areas of compression, which result in further fracturing of the kernels, or propagation of existing fractures within the kernels. To avoid the overmilling present in the prior art, perforations 1010 are sufficiently sized to permit sufficiently milled brokens to exit the milling chamber 404 through screen 1000. Thus, kernels that are sufficiently fractured early in the milling process do not continue to be milled after passing through screen 1000.

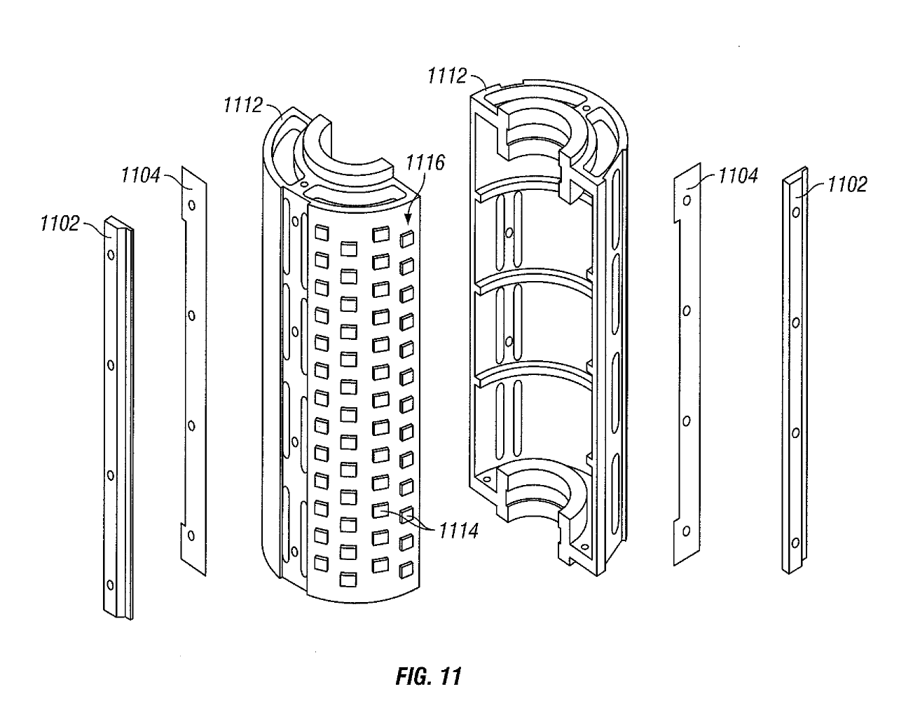

As described above, as a resistor bar 602 mounted on milling rotor 412 rotates past a breaker bar 1032, a localized area of compression is created and released, causing fracture propagation through the materials to be milled. As illustrated in FIG. 11, this propagation is further encouraged by a modification to the milling rotor 1112, which includes not only the resistor bars 1102 and the spacer 1104 between the resistor bar 1102 and the milling rotor 1112 but also a plurality of resistor prisms 1114 arrayed across the milling rotor 1112 co-planar with the first row 1016 of breaker bars 1014 and the second row 1034 of breaker bars 1032. In the preferred embodiment, the milling rotor 1112 includes three (3) resistor bars 1102. Intermediate the resistor bars 1102 are five (5) equally laterally-distributed columns 1116 of resistor prisms 1114, for a total of fifteen (15) equally laterally-distributed columns 1116 of resistor prisms 1114. Each resistor prism 1114 is a square protuberance. In the present embodiment each resistor prism measures 16 mm on each side and having a height of 6 mm, although the number of columns, rows and size of resistor prisms 1114 may be changed. Resistor prisms 1114 may be of any other shape, such as cylindrical, or any number of shapes. Each column 1116 is advanced over the prior column 1116 to present an alternating presence of resistor prisms 1114. Thus, in operation, rotation of milling rotor 1112 not only induces localized areas within the milling chamber 404 where all materials to be milled in a vertical plane are equally induced to move laterally, but, by virtue of the alternating and discrete resistor prisms, vertical layers of materials to be milled are induced to move with varied force, thus inducing greater interaction among them. Moreover, the spacing between columns 116 of resistor prisms 1114 permits the force imparted to the materials to be milled in the milling chamber 404 to vary as they approach a breaker bar 1014 or 1032.

In operation, the application of friction and intermittent compressive force among materials to be milled within milling chamber 404, between materials to be milled and the screen 1000, and between the materials to be moved and the breaker bars 1014 and 1032 results in the separation of some or all of bran 102, the fracturing of endosperm 106 into endosperm particles 107, and the freeing of a substantial portion of germ 106 without overmilling. By maximizing the size of endosperm particles 107 and freed germ 106, the highest value of the kernel may be realized.

Germ 104 maintained in its whole state provides greater oil production. Endosperm 106 maintained in its whole state or in large brokens is suitable for high value end uses.

This construction, together with the addition of a second row 1034 of breaker bars 1032 has been found to produce superior results. In particular, the 9 mm diameter perforation and their relative quantity per unit area has resulted in a high through stock with reduced tails. This construction has produces results the inverse of the prior art, with the majority of product exiting the mill as throughs. This increased through production, however, without further improvement to mill 400, creates additional problems.

Referring to FIG. 4, in the prior art, the throughs are removed from the mill 400 at the bottom of the screen 410 into a through removal passage 422 by a paddle 424 affixed to the lower section of the milling rotor 412. The removal passage 422 was connected to a negative or reduced pressure system 426, such as a such as a vacuum pump, to draw the throughs along the piping 428, laterally and/or vertically, and to a throughs collector 430. This is typically accomplished by a pump 426 communicating with the through removal passage 422. The increase in throughs generated by the present invention, often at least double the throughs generated by the prior art, would require a substantial increase in pump capacity and therefore a significant increase in energy expenditure.

Referring to FIG. 10, in a further embodiment, each of front screen 1002 and/or rear screen 1004 may be assembled from three (3) separate sections. Use of a first or top section 1008, second or middle section 1030, and bottom or third section 1050 as segments of front screen 1002 and/or rear screen 1004 permits interchange for replacement of screen sections with attached breaker bars. Similarly, segmented front screen 1002 and/or rear screen 1004 permits use of varying, including multiple, types of perforations 1010. More than three (3) sections may be used, but three sections permits replacement of an entire section which may include breaker bars.

As illustrated in FIG. 12, the present invention may further include a gravity removal system for through removal. Rather than attempting to remove throughs from the mill 1200 entirely by negative or reduced pressure, mill 1200 includes a through removal passage 1220 located adjacent the bottom of the milling chamber 1204 and paddle 1224 and connected to piping 1228 which depends downwardly, thus using gravity to move throughs from the mill 1200 and to fall to through collector 1222. Collector 1222 may include a rotary air seal or lock, or other similar equipment, to separate piping 1228 from aspirator 1230, thereby maximizing the reduced pressure drawn on piping 1228. Ideally, collector 1222 does not permit pump 1226 to draw air from aspirator 1230. Once induced toward the through collector 1222, which may be a hopper, by pump 1226, the throughs may be separated by density in an aspirator 1230. A greater portion of throughs may therefore be handled by the mill 1200.

The process of this invention is further illustrated in the following example of wet milling, although the invention may also be used for dry milling.

### EXAMPLE

In the first step, water is added to a fixed quantity of whole corn kernels. Specifically, for #2 grade yellow corn, introduced to tempering at 7452 kg/hr with water is added at approximately 5% by weight at a rate of 373 liter/hr. The whole corn kernels are then retained in a holding tank for a period of six minutes.

Next the corn kernels are introduced to a Satake Maize Degermer VBF modified with the screen and breaker bars described herein with a milling rotor rotating at 800 revolutions per minute (RPM). Two distinct stock separations—overtails and throughs—are generated. The overtails, referring to the product which does not pass through the 9 mm round perforated screen, consists generally of generally-debranned corn kernels (endosperm and germ) although some bran remains attached to the endosperm and germ, as well as some throughs which did not pass through the screen. The throughs, referring to product which has passed through the 9 mm round perforated screen, consists of bran, endosperm and germ reduced in size to less than 9 mm in diameter.

A first sample bag of overtails, weighing 4.54 kg, is produced over a 20 second period.

A second sample bag of overtails, weighing 4.48 kg, is produced over a farther 20 second period.

In the example, the two 20 second time periods are proximate, but separated by some short time during bag change.

Overtails are therefore produced at an average rate of 811.6 kg/hr.

A first bag of throughs, weighing 18.25 kg, is produced in 10 seconds.

A second bag of throughs, weighing 18.25 kg, is produced in 10 seconds.

Throughs are therefore produced at an average rate of 6640.23 kg/hr.

Overtails constitute 10.9% of the output. Throughs constitute 89.1% of the output. Sifting and aspiration, not included in this example, would separate the majority of the endosperm grit from the bran so the recovered endosperm may go to conventional purification and reduction, and ultimately become a useful end product.

This configuration provides improved processing and removal of sufficiently milled germ.

The terms and expressions which have been employed in the foregoing specification are used therein as terms of description and not of limitation, and there is no intention, in the use of such terms and expressions, of excluding equivalents of the features shown and described or portions thereof.

1. A vertical mill for fragmenting grains, comprising:
a vertically-disposed rotor,
said rotor having height;
a resistor bar connected to said milling rotor,
said resistor bar having length,
said resistor bar length approximate said rotor height;
a screen surrounding said milling rotor,
said screen having height,
said screen height approximate said resistor bar length,
said screen having an upper section, a middle section, and a bottom section,
said screen having a plurality of perforations therethrough arranged in rows in said upper section, said middle section and said bottom section;
a milling chamber bounded by said screen,
said milling chamber having a top and a bottom;
a feed inlet proximate said bottom of said milling chamber,
said feed inlet communicating with said milling chamber;
a discharge outlet proximate said top of said milling chamber;
said discharge outlet communicating with said milling chamber;
a first row of first vertically-oriented breaker bars spanning said upper section;
a second row of second vertically-oriented breaker bars spanning said middle section.

2. The vertical mill of claim 1, further comprising
a removal passage communicating with said milling chamber;
said removal passage adjacent said bottom of said milling chamber;
said removal passage downwardly communicating with a throughs collector;
said removal passage communicating with a negative pressure system.

3. The vertical mill of claim 2, further comprising
a plurality of laterally-distributed columns of resistor prisms are affixed to said rotor, said resistor prisms positioned coplanar with said upper section of said screen and said middle section of said screen.

4. The vertical mill of claim 3, wherein
said bottom section of said screen is independently removable.

5. The vertical mill of claim 4, wherein
said upper section of said screen is approximately one-third of said screen; and
said middle section of said screen is approximately one-third of said screen.

6. The vertical mill of claim 5, wherein
said perforations are sufficiently sized to communicate a substantial portion of fragments from said milling chamber to said removal passage.

7. The vertical mill of claim 6, wherein
said perforations are round; and
said perforations are not less than 6 mm in diameter and not more than 10 mm in diameter.

8. The vertical mill of claim 7, wherein
said resistor prisms are rectangular prisms.

9. The vertical mill of claim 1, further comprising
a plurality of laterally-distributed columns of resistor prisms are affixed to said rotor,
said resistor prisms positioned coplanar with said upper section of said screen and said middle section of said screen.

10. The vertical mill of claim 9, wherein
said bottom section of said screen is independently removable.

11. The vertical mill of claim 10, wherein
said upper section of said screen is approximately one-third of said screen; and
said middle section of said screen is approximately one-third of said screen.

12. The vertical mill of claim 11, wherein
said perforations are sufficiently sized to communicate a substantial portion of fragments from said milling chamber to said removal passage.

13. The vertical mill of claim 12, wherein
said resistor prisms are rectangular prisms.

14. The vertical mill of claim 12, wherein
said perforations are round; and
said perforations are not less than 6 mm in diameter and not more than 10 mm in diameter.

15. A mill for fragmenting grains, comprising:
a disposed rotor,
said rotor having length;
a resistor bar connected to said milling rotor,
said resistor bar having length,
said resistor bar length approximate said rotor length;
a screen surrounding said milling rotor,
said screen having length,
said screen length approximate said resistor bar length,
said screen having an first section, a second section, and a third section,
said screen having a plurality of perforations therethrough arranged in rows in said first section, said second section and said third section;
a milling chamber bounded by said screen,
said milling chamber having a second end and a first end end;
a feed inlet proximate said first end of said milling chamber,
said feed inlet communicating with said milling chamber;
a discharge outlet proximate said second end of said milling chamber;
said discharge outlet communicating with said milling chamber;
a first row of first vertically-oriented breaker bars spanning said first section;
a second row of second vertically-oriented breaker bars spanning said second section.

16. The mill of claim 15, further comprising
a plurality of laterally-distributed columns of resistor prisms are affixed to said rotor,
said resistor prisms positioned coplanar with said first section of said screen and said second section of said screen.

17. The mill of claim 16, wherein
said third section of said screen is independently removable.

18. The mill of claim 17, wherein
said upper section of said screen is approximately one-third of said screen; and
said middle section of said screen is approximately one-third of said screen.

19. The mill of claim 18, wherein
said perforations are sufficiently sized to communicate a substantial portion of fragments from said milling chamber to said removal passage.

20. The mill of claim 19, wherein
said resistor prisms are rectangular prisms.

21. A method for milling grain, comprising:
continuously introducing said grains into a vertical milling chamber proximate the bottom of said vertical milling chamber, said vertical milling chamber bounded by a screen, said screen having an upper section, middle section and lower sections, said screen having rows of perforations in said upper section, middle section and lower sections, said vertical milling chamber having height;
forcing said grains vertically toward the top of said vertical milling chamber by said introduced grains;
continuously rotating a vertically-disposed rotor having a resistor bar within said vertical milling chamber, said resistor bar moving adjacent grains, said rotor having height, said resistor bar having height, said screen height approximate said rotor height, said rotor height approximate said resistor bar height;
inducing friction among said grains by said moving grains;
retarding a portion of said grains by contact with a first row of first breaker bars spanning the middle section of said screen;
increasing said friction among said grains by said retarded portion of grains;
retarding a potion of said grains by contact with a second row of second breaker bars spanning the top section of said screen;
increasing said friction among said grains by said retarded portion of said grains;
retaining by said perforated screen unbroken grains within said vertical milling chamber;
permitting corn fragments smaller than said perforations in said screen to escape said vertical milling chamber;
discharging said grains and the remaining fragments through a discharge outlet through said screen at said upper section of said screen proximate said top of said milling chamber.

22. The method of claim 21, further comprising
communicating downwardly said corn fragments smaller than said perforations in said screen to a throughs collector via a removal passage adjacent said bottom of said milling chamber;
drawing a reduced pressure on said removal passage.

23. The method of claim 22, wherein said rotor further includes a plurality of laterally-distributed columns of resistor prisms are affixed to said rotor, said resistor prisms positioned coplanar with said upper section of said screen and said middle section of said screen.
